(19) United States
(12) Patent Application Publication
(10) Pub. No.: US 2012/0122331 A1
(43) Pub. Date: May 17, 2012

(54) Electrical Connector

(76) Inventors: Yu Cheng, Shanghai (CN); Huibin Li, Shanghai (CN); Wei Yao, Shanghai (CN)

(21) Appl. No.: 13/297,462

(22) Filed: Nov. 16, 2011

(30) Foreign Application Priority Data
Nov. 16, 2010 (CN) 201010551933.1

(51) Int. Cl. H01R 13/62

(52) U.S. Cl. 439/327

(57) ABSTRACT

An electrical connector includes an insulation body and a pair of securing mechanisms. The insulation body includes a card receiving passageway for receiving an electrical card therein. The pair of securing mechanisms are individually positioned at both ends of the insulation body. Each of the securing mechanisms includes a rotation member rotatably connected to the insulation body and rotatable about a vertical axis between a locked position and an unlocked position of the electrical card.

### CROSS-REFERENCE TO RELATED APPLICATION

This application claims the benefit under 35 U.S.C. §119 (a)-(d) of Chinese Patent Application No. 201010551933.1 filed on Nov. 16, 2010.

### FIELD OF THE INVENTION

The present invention relates to an electrical connector, more particularly, relates to an electrical connector with a securing mechanism for an electrical card.

### BACKGROUND

In personal computers and the other electrical apparatus, various electrical connectors are assembled on a circuit board for inserting various electrical cards therein to achieve an electrical connection between the electrical cards and the circuit board. Generally, in order to improve the connection stability of the electrical cards and the circuit board, various securing mechanisms are used to lock the electrical cards on the electrical connectors.

In one type of the known electrical connectors, for example, as disclosed in a Chinese Patent Publication No. CN2395403, two securing mechanisms are respectively positioned at both ends of an insulation body of the electrical connector. The securing mechanism has a pivot mechanism that is received in a hole of the insulation body and is rotated about a horizontal axis, which is perpendicular to an insertion direction of the electronic card, relative to the insulation body. When it needs to unlock the electrical card, the securing mechanisms are rotated outward f from the ends of the insulation body about the horizontal axis. Accordingly, there is a need to leave enough space for the securing mechanisms along the outsides of both ends of the insulation body in order to ensure that the securing mechanisms can be smoothly rotated to the unlocked position.

In another type of the known electrical connectors, for example, as disclosed in a Chinese Patent Publication No. CN201041840, two securing mechanisms are respectively positioned at both ends of an insulation body of the electrical connector. Each securing mechanism is an elastic member and can be pulled outward from the end of the insulation body to unlock the electrical card. However, for this type of electrical connector, similar as the above one, it also needs to leave enough space along the outsides of both ends of the insulation body in order to ensure that the electrical card can be smoothly unlocked.

Obviously, because it needs to leave enough large space for the securing mechanisms in the known electrical connectors, these known electrical connectors cannot be manufactured very compact in size.

### SUMMARY

The invention has been made to overcome or alleviate at least one aspect of the above mentioned disadvantages. Accordingly, It will be advantageous to provide an electrical connector which is can be manufactured more compact than before.

An electrical connector includes an insulation body and a pair of securing mechanisms. The insulation body includes a card receiving passageway for receiving an electrical card (300) therein. The pair of securing mechanisms are individually positioned at both ends of the insulation body. Each of the securing mechanisms includes a rotation member rotatably connected to the insulation body and rotatable about a vertical axis between a locked position and an unlocked position of the electrical card.

In various embodiments of the invention, since the securing mechanism can lock and unlock the electrical card by rotation about the vertical axis, the securing mechanism does not need occupy a longitudinal outside space of the end of the insulation body during unlocking the electrical card, so that the longitudinal size of the insulation body can be reduced so as to achieve a compact electrical connector.

### BRIEF DESCRIPTION OF THE DRAWINGS

The above and other features of the present invention will become more apparent by describing in detail embodiments thereof with reference to the accompanying drawings, in which:

FIG. 1 is an exploded view of an electrical connector according to the invention;

FIG. 2 is a perspective view of a rotation member of the electrical connector shown in FIG. 1;

FIG. 3 is a partial perspective view of an end of an insulation body of the electrical connector shown in FIG. 1;

FIG. 4 is a perspective view of a rotation member that is pivot mechanically connected to the insulation body according to the invention, with an electrical card not yet inserted into a card receiving passageway of the insulation body;

FIG. 5 is a perspective view of the electrical card inserted into the card receiving passageway of the insulation body;

FIG. 6 is a perspective of the rotation member being rotated to a locked positioned where the electrical card is locked in the card receiving passageway of the insulation body according to the invention;

FIG. 7 is a top view of the electrical connector according to the invention, wherein a rotation member is positioned in an unlocked position; and

FIG. 8 is a top view of the electrical connector shown in FIG. 7, wherein the rotation member is positioned in a locked position.

### DETAILED DESCRIPTION OF THE EMBODIMENT(S)

Embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

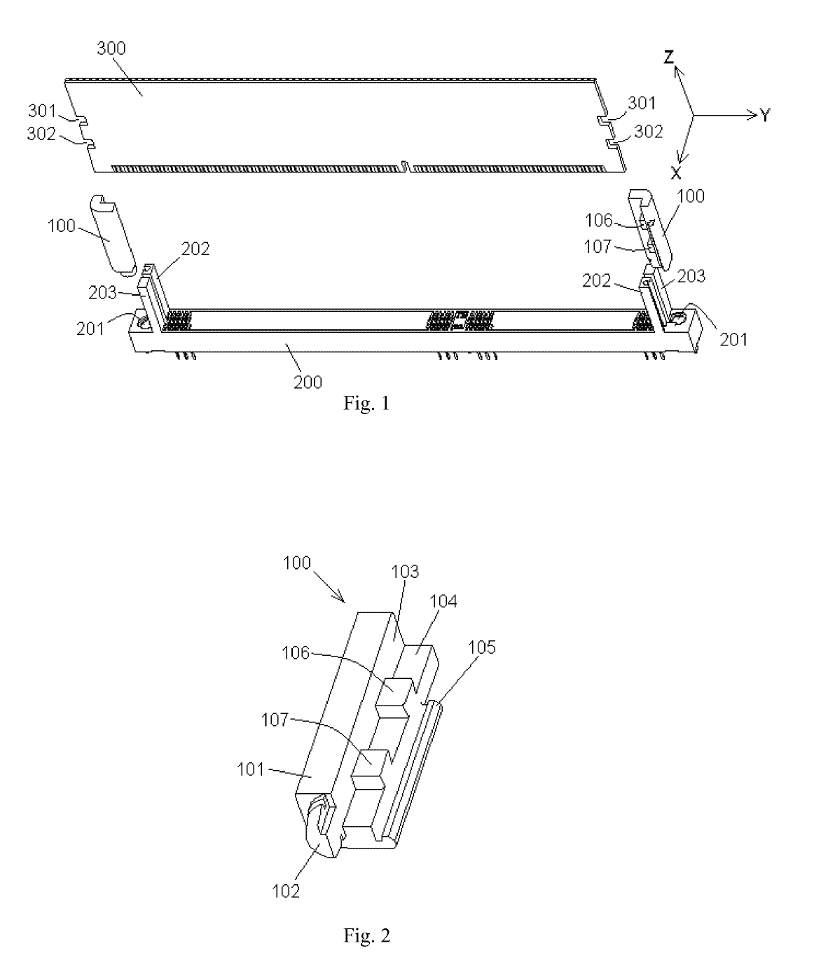

As shown in FIG. 1, the electrical connector according to the invention includes an elongated insulation body 200 and a pair of securing mechanisms positioned respectively at both ends of the insulation body 200.

For the purpose of clearly describing the invention, a coordinate system is shown, wherein X-axis denotes a width direction of the insulation body 200, Y-axis denotes a length direction of the insulation body 200, and Z-axis denotes a vertical direction perpendicular to both the length and width directions of the insulation body 200, which is also the direction that an electrical card 300 is inserted into or pulled out the insulation body 200.

A card receiving passageway extending in the length direction Y is disposed in the insulation body 200. As shown in FIG. 1, the electrical card 300 is inserted into the card receiving passageway and is electrically connected to the electrical connector, and the electrical connector is electrically connected to a circuit board (not shown) by connection portions (for example, legs or pins) disposed at the bottom of the insulation body 200. In this way, the electrical card 300 may be electrically connected to the circuit board through the electrical connector according to the invention.

As shown in FIGS. 1-3, each of the securing mechanisms includes a rotation member 100 and a pair of posts 202, 203.

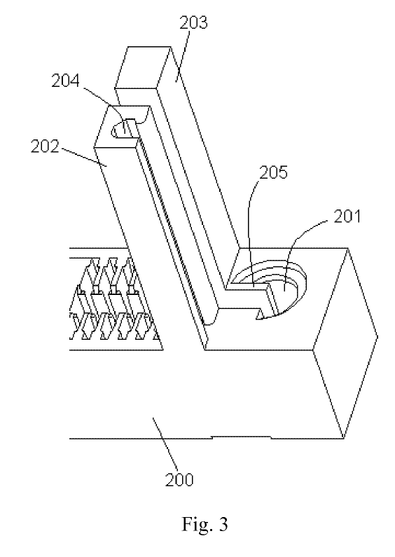

Please refer to FIGS. 2 and 3, the rotation member 100 has a pivot mechanism 102 at a lower portion thereof, and the insulation body 200 has a pivot mechanism receiving space 201 in which the pivot mechanism 102 is rotatably fitted. As shown in FIGS. 2 and 3, the pivot mechanism 102 and the pivot mechanism receiving space 201 both have a rotation axis in the vertical axis. Accordingly, the rotation member 100 is configured to be rotated about the vertical Z-axis.

But, the invention is not limited to the configuration shown in FIGS. 1-3. For example, in another embodiment of the present invention, the rotation member 100 may be formed with a hole at a lower portion thereof, and the insulation body 200 may be formed with a pivot mechanism that is rotatably fitted in the hole of the rotation member 100.

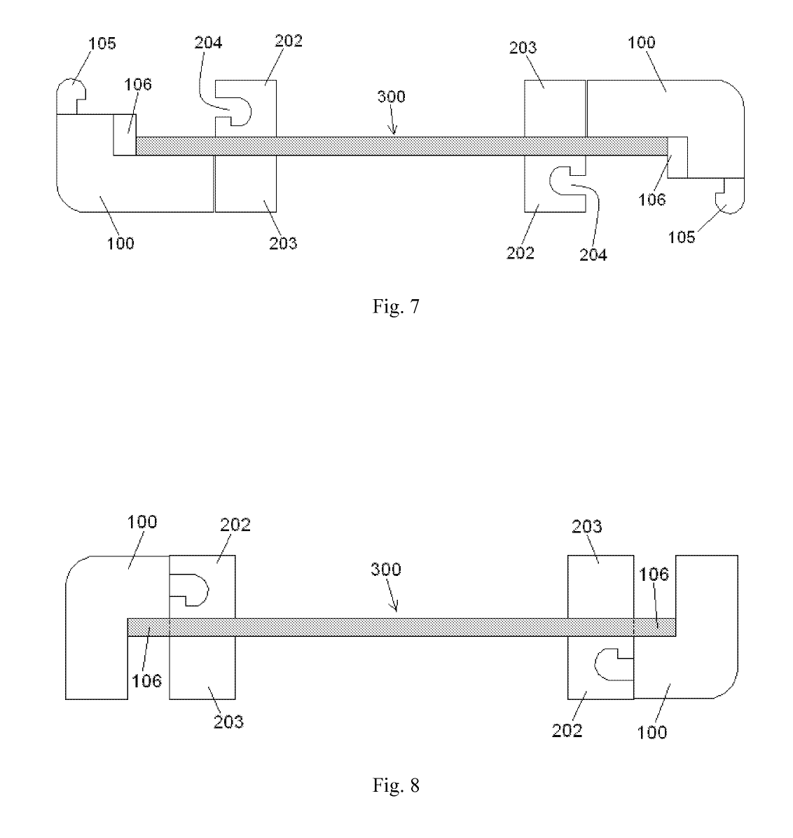

According to the electrical connector of the invention, the rotation member 100 is configured to be rotated about the vertical Z-axis from an unlocked position where the electrical card 300 is unlocked (refer to FIG. 5 or FIG. 7) to a locked position where the electrical card 300 is locked (refer to FIG. 6 or FIG. 8). On the one hand, when the rotation member 100 is rotated to the locked position (refer to FIG. 6 or FIG. 8), the rotation member 100 is snap-fit by both the electrical card 300 and the insulation body 200 to ensure that the electrical card 300 may be stably secured on the insulation body 200 of the electrical connector. On the other hand, when the rotation member 100 is rotated to the unlocked position (refer to FIG. 5 or FIG. 7), the rotation member 100 is disengaged from both the electrical card 300 and the insulation body 200 to ensure that the electrical card 300 may be easily pulled out from the insulation body 200 of the electrical connector.

In a shown embodiment of FIGS. 1-3, two protuberances 106, 107 are formed on a side of the rotation member 100. Two notches 301, 302 are formed along an edge of the electrical card 300. On the one hand, when the rotation member 100 is rotated to the locked position, the protuberances 106, 107 of the rotation member 100 are respectively secured by the notches 301, 302 of the electrical card 300. On the other hand, when the rotation member 100 is rotated to the unlocked position, the protuberances 106, 107 of the rotation member 100 respectively disengage from the notches 301, 302 of the electrical card 300.

Please note that the number of the protuberances 106, 107 and the notches 301, 302 is not limited to the configurations shown in drawings of the invention, but may include only one, or may be three, four or more protuberances 106, 107 and/or the notches 301, 302.

With reference back to FIGS. 1-3, in an embodiment of the invention, a protrusion rib 105 is formed at a side edge of the rotation member 100, and a rib receiving passageway 204 mated with the protrusion rib 105 is formed in the insulation body 200. On the one hand, when the rotation member 100 is rotated to the locked position, the protrusion rib 105 of the rotation member 100 is snapped by the rib receiving passageway 204 of the insulation body 200. On the other hand, when the rotation member 100 is rotated to the unlocked position, the protrusion rib 105 of the rotation member 100 is disengaged from the rib receiving passageway 204 of the insulation body 200.

But, the present invention is not limited to the configuration shown in FIGS. 1-3. For example, in another embodiment of the present invention, a groove may be formed in a side edge of the rotation member 100 and may be secured by a protrusion rib formed on the insulation body 200 when the rotation member 100 is rotated to the locked position.

As shown in FIG. 2, a body 101 of the rotation member 100 includes a pair of side surfaces 103, 104 that are perpendicular to each other and form a recessed side wall. The protuberances 106, 107 are disposed on one of the pair of side surfaces 103, 104.

As shown in FIGS. 1-3, the pair of posts 202, 203 at each end of the insulation body 200 are opposite to each other and are spaced by a predetermined gap. In shown embodiment of the invention, the gap may be slightly less than the thickness of the electrical card 300 so that the end of the electrical card 300 may be tightly sandwiched between the pair of posts 202, 203 to limit a movement of the electrical card 300 in the width direction X of the insulation body 200.

As shown in FIG. 3, the rib receiving passageway 204 is disposed between one of the pair of posts 202, 203. In a shown embodiment of the invention, the protrusion rib 105 of the rotation member 100 has an elongated-bar shape, and the rib receiving passageway 204 of the one post 202 is shaped to receive the protrusion rib 105.

Please refer to FIG. 3, the top of the rib receiving passageway 204 in the post 202 is constructed to be opened. But the top of the rib receiving passageway 204 in the post 202 may be constructed to be closed to further prevent the movement of the rotation member 100 in the vertical direction Z.

As shown FIG. 1, FIG. 7 and FIG. 8, the pair of securing mechanisms, respectively located at both ends of the insulation body 200, are diagonally symmetrical about a center of the insulation body 200. When the pair of securing mechanisms rotate to the locked position, the pair of securing mechanisms are respectively positioned along both sides of the electrical card 300, which may further improve the stability of the securing mechanisms. However, please note that, in the invention, the pair of securing mechanisms may be positioned along the same side of the electrical card when they are in the locked position.

In another embodiment of the invention, the rotation angle of the rotation member 100 from the locked position shown in FIG. 7 to the unlocked position shown in FIG. 8 may be 90 degrees. But, the present invention is not limited to this design, and the rotation angle may be designed different from 90 degrees.

Please refer to FIG. 3 again. One post 203 extends into the pivot mechanism receiving space 201. The vertical wall 205 is mated with a recess (not shown) in the pivot mechanism 102 of the rotation member 100 to assist the rotation of the rotation member 100. That is, the pivot mechanism 102 may rotate about the vertical end edge of the vertical wall 205. In addition, the vertical wall 205 abuts the surface of the electrical card 300 to further prevent the movement of the electrical card 300 in the width direction.

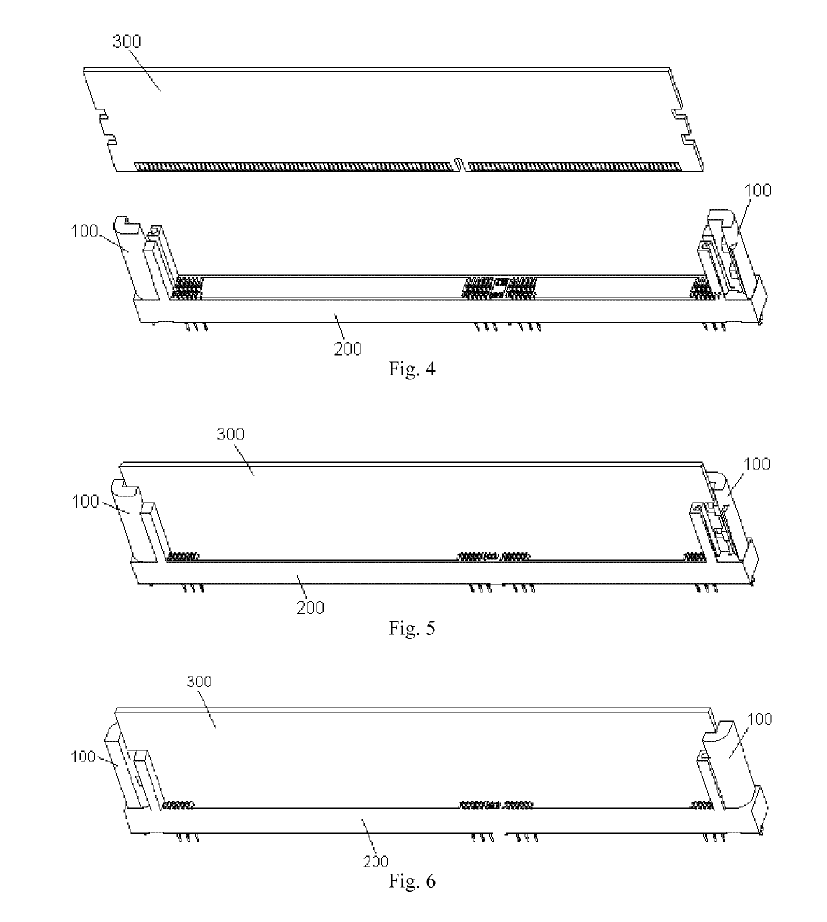

FIG. 4 to FIG. 6 illustrate the procedure of inserting and locking the electrical card 300 in the electrical connector according to the invention. In FIG. 4, the rotation member 100 is pivotally connected to the insulation body 200 and the electrical card 300 is not yet inserted into a card receiving passageway of the insulation body 200. In FIG. 5, the electrical card 300 is inserted into the card receiving passageway of the insulation body 200. In FIG. 6, the rotation member 100 is rotated from a position where the electrical card 300 is unlocked to a position where the electrical card 300 is locked.

The procedure of inserting and locking the electrical card 300 includes:

(1) As shown in FIG. 4, the rotation members 100 are disposed in the pivot mechanism receiving spaces 201 of the insulation body 200 and then rotated about the vertical axis to an unlocked position;

(2) As shown in FIG. 5, the electrical card 300 is inserted into the card receiving passageway of the insulation body 200; and

(3) As shown in FIG. 6, the rotation members 100 are rotated to the locked position about the vertical axis to lock the electrical card 300 on the insulation body 200.

Although several embodiments have been shown and described, it would be appreciated by those skilled in the art that various changes or modifications may be made in these embodiments without departing from the principles and spirit of the disclosure, the scope of which is defined in the claims and their equivalents. Further, the singular forms “a”, “an” and “the” are intended to include the plural forms as well, unless the context clearly indicates otherwise. In addition, the reference numbers used in the claims are for the purpose of describing particular embodiments only and are not intended to be limiting of example embodiments of the invention.

What is claimed is:

1. An electrical connector, comprising:
an insulation body having a card receiving passageway for receiving an electrical card therein; and
a pair of securing mechanisms individually positioned at each end of the insulation body with each of the securing mechanisms including a rotation member rotatably connected to the insulation body and rotatable about an axis (Z) between a locked position and an unlocked position of the electrical card.

2. The electrical connector according to claim 1, wherein each rotation member includes a pivot mechanism at a lower portion thereof, and the insulation body has a pivot mechanism receiving space in which the pivot mechanism is rotatably fitted.

3. The electrical connector according to claim 2, wherein a protuberance is (A) disposed on a side of the rotation member and (B) adapted for receiving a notch that is disposed along an edge of the electrical card when the rotation member is rotated to the locked position.

4. The electrical connector according to claim 3, wherein a protuberance is (A) disposed on a side of the rotation member and (B) adapted for receiving a notch that is disposed along an edge of the electrical card when the rotation member is rotated to the locked position.

5. The electrical connector according to claim 4, wherein each of the pair of securing mechanisms further includes a pair of posts disposed on the insulation body and spaced apart a gap.

6. The electrical connector according to claim 5, wherein the pair of posts receive the electrical card in the gap between the posts to limit movement of the electrical card in a width direction (X) of the insulation body.

7. The electrical connector according to claim 6, wherein the rib receiving passageway is formed in one of the pair of posts.

8. The electrical connector according to claim 7, wherein the protrusion rib is a bar.

9. The electrical connector according to claim 8, wherein the rib receiving passageway is shaped to correspond and mate with that of the protrusion rib.

10. The electrical connector according to claim 8, wherein the rotation member includes a pair of side surfaces positioned perpendicular to each other.

11. The electrical connector according to claim 10, wherein the protuberance is formed on one of the pair of side surfaces.

12. The electrical connector according to claim 11, wherein the pair of securing mechanisms are positioned diagonally symmetrical with respect to each other about a center of the insulation body.

13. The electrical connector according to claim 12, wherein a rotation angle of the rotation member from the locked position to the unlocked position is about 90 degrees.
